(19) United States
(12) Patent Application Publication
(10) Pub. No.: US 2019/0001558 A1
(43) Pub. Date: Jan. 3, 2019

(54) COMPOSITION INCLUDING A HIGH MELT TEMPERATURE BUILD MATERIAL

(71) Applicant: Hewlett-Packard Development Company, L.P., Houston, TX (US)

(72) Inventors: Krzysztof Nauka, Palo Alto, CA (US); Kristopher J. Erickson, Palo Alto, CA (US); Howard S. Tom, Palo Alto, CA (US); Lihua Zhao, Palo Alto, CA (US)

(73) Assignee: Hewlett-Packard Development Company, L.P., Houston, TX (US)

(21) Appl. No.: 16/073,613

(22) PCT Filed: Apr. 27, 2016
(86) PCT No.: PCT/US2016/029520

§ 371 Date: Jul. 27, 2018

(51) Int. Cl. B29C 64/165; B28B 1/00; B22F 3/00; B33Y 10/00; B33Y 70/00; B33Y 40/00; B33Y 50/02

(52) U.S. Cl. CPC B29C 64/165; B28B 1/001; B22F 3/008; B33Y 50/02; B33Y 70/00; B33Y 40/00; B33Y 10/00

(57) ABSTRACT

According to an example, a composition may include a high melt temperature build material in the form of a powder; a first low melt temperature binder in the form of a powder; and a second low melt temperature binder in the form of a powder, and in which the first low melt temperature binder melts at a temperature that is different from the second low melt temperature binder.

### BACKGROUND

In three-dimensional (3D) printing, an additive printing process may be used to make three-dimensional solid parts from a digital model. 3D printing techniques are considered additive processes because they involve the application of successive layers of material. This is unlike traditional machining processes, which often rely upon the removal of material to create the final part. In 3D printing, the building material may be cured or fused, which for some materials may be performed using heat-assisted extrusion, melting, or sintering, and for other materials, may be performed using digital light projection technology.

### BRIEF DESCRIPTION OF THE DRAWING

Features of the present disclosure are illustrated by way of example and not limited in the following figure(s), in which like numerals indicate like elements, in which:

FIG. 1 shows a simplified isometric view of an example three-dimensional (3D) printer for generating, building, or printing three-dimensional parts; and

FIGS. 2 and 3, respectively, show flow diagrams of example methods of fabricating a 3D part.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein are a 3D printer, methods for implementing the 3D printer to form a 3D part, and a composition for use in the method. A 3D part may be printed, formed, or otherwise generated onto a build area platform. The 3D printer may also include a spreader to spread a layer of a composition onto the build area platform, and a printhead to selectively deposit an agent. The 3D printer may form successive layers of the composition, which may be spread and may receive the agent. Energy may be applied to form a green body of the 3D part that is ultimately to be formed. The green body may be removed from the extra composition that does not form part of the green body and may then be exposed to heating and/or radiation to melt, sinter, densify, fuse, and/or harden the green body to form the 3D part. As used herein “3D printed part,” “3D part,” “3D object,” “object,” or “part” may be a completed 3D printed part or a layer of a 3D printed part.

The composition for use in a method of forming 3D parts may include a high melt temperature build material in the form of a powder, a first low melt temperature in the form of a powder, and a second low melt temperature in the form of a powder. In an example, the composition may include additional low melt temperature binders, such as a third, a fourth, a fifth, etc. The high melt temperature build material may be present in the composition in an amount ranging from about 5% to about 99.9% by volume, for example from about 30% to about 95% by volume, and as a further example from about 50% to about 90% by volume.

The high melt temperature build material in the form of a powder may be selected from the group consisting of metals, metal alloys, ceramics, and polymers. Non-limiting examples of metals include alkali metals, alkaline earth metals, transition metals, post-transition metals, lanthanides, and actinides. The alkali metals may include lithium, sodium, potassium, rubidium, cesium, and francium. The alkaline earth metals may include beryllium, magnesium, calcium, strontium, barium, and radium. The transition metals may include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, and gold. The post-transition metals include aluminum, indium, tin, thallium, lead, and bismuth. In an example, the high melt temperature build material may be chosen from aluminum, copper, Ti₈Al₄V, AlSi₁₀Mg, bronze alloys, stainless steel, Inconel, and cobalt-chromium, and nickel-molybdenum-chromium alloys. The metals for use as the high melt temperature build material may have a melting point temperature ranging from about 250° C. to about 3400° C., for example from about 275° C. to about 3000° C., and as a further example from about 300° C. to about 2500° C.

Non-limiting examples of metal alloys include steel, solder, pewter, duralumin, phosphor bronze, amalgams, stainless steel alloys 303, 304, 310, 316, 321, 347, 410, 420, 430, 440, PH13˜8,17˜4PH; Fe/Ni, Fe/Si, Fe/Al, Fe/Si/Al, Fe/Co, magnetic alloys containing Fe/Co/V; satellite 6 cobalt alloy including satellites 12; copper, copper alloys, bronze (Cu/Sn), brass (Cu/Zn), tin, lead, gold, silver, platinum, palladium, iridium, titanium, tantalum, iron, aluminum alloys, magnesium including alloys, iron alloys, nickel alloys, chromium alloys, silicon alloys, zirconium alloys, gold alloys, and any suitable combination. The metal alloys for use as the high melt temperature build material may have a melting point temperature ranging from about 250° C. to about 3400° C., for example from about 275° C. to about 3000° C., and as a further example from about 300° C. to about 2500° C.

The ceramics may be nonmetallic, inorganic compounds, such as metal oxides, inorganic glasses, carbides, nitrides, and borides. Some specific examples include alumina (Al₂O₃), Na₂O/CaO/SiO₂ glass (soda-lime glass), silicon carbide (SiC), silicon nitride (Si₃N₄), silicon dioxide (SiO₂), zirconia (ZrO₂), yttrium oxide-stabilized zirconia (YTZ), titanium dioxide (TiO₂), or combinations thereof. In an example, the high melt temperature build material may be a cermet (a metal-ceramic alloy). The ceramics for use as the high melt temperature build material may have a melting point temperature ranging from about 1000° C. to about 2000° C., for example from about 1100° C. to about 1900° C., and as a further example from about 1200° C. to about 1800° C.

The high melt temperature build material may be a polymer. Non-limiting examples of a suitable polymer include polyamide-imides, high-performance polyamides, polyimides, polyketones, polysulfone derivatives, fluoropolymers, polyetherimides, polybenzimidazoles, polybutylene terephthalates, polyphenyl sulfides, polystyrene, and syndiotactic polystyrene. The polymer for use as the high melt temperature build material may have a melting point temperature ranging from about 200° C. to about 400° C. for example from about 250° C. to about 300° C., and as a further example from about 270° C. to about 360° C.

The composition may include a first low melt temperature binder in the form of a powder and a second low melt temperature binder in the form of a powder. The first low melt temperature binder may be different from the second low melt temperature binder. The first low melt temperature binder and a second low melt temperature binder may each be a crystalline polymer, such as polypropylene and polyethylene. The first low melt temperature binder and the second low melt temperature binder may each be a non-crystalline polymer, such as polyethylene oxide, polyethylene glycol (solid), acrylonitrile butadiene styrene, polystyrene, styrene-acrylonitrile resin, and polyphenyl ether. In an example, the first low melt temperature binder may melt at a temperature that is different from the second low melt temperature binder. The first low melt temperature binder and the second low melt temperature binder may be independently selected from the group consisting of polypropylene, polyethylene, low density polyethylene, high density polyethylene, polyethylene oxide, polyethylene glycol, acrylonitrile butadiene styrene, polystyrene, styrene-acrylonitrile resin, polyphenyl ether, polyamide 11, polyamide 12, polymethyl pentene, polyoxymethylene, polyethylene terephthalate, polybutylene terephthalate, polyvinylidene fluoride, polytetrafluoroethylene, perfluoroalkoxy alkane, polyphenylene sulfide, and polyether ether ketone.

The first low melt temperature binder and the second low melt temperature binder may have a melting point temperature less than about 250° C., for example it may range from about 50° C. to about 249° C., for example from about 60° C. to about 240° C. and as a further example from about 70° C. to about 235° C.

The first low melt temperature binder and the second low melt temperature binder may be present in the composition in an amount ranging from about 1% to about 6% by volume, for example from about 2% to about 5%, and as a further example from about 3% to about 5% by volume. In an example, the composition may have about 95% by volume of copper powder and about 5% by volume of polypropylene powder. The amount of the first low melt temperature binder and the second low melt temperature binder may be chosen to provide shape integrity to the green body after the binders have melted and solidified.

The composition may further include other suitable binders such as sugars, sugar alcohols, polymeric or oligomeric sugars, low or moderate molecular weight polycarboxylic acids, polysulfonic acids, water soluble polymers containing carboxylic or sulfonic moieties, and polyether alkoxy silane. Some specific examples include glucose (C₆H₁₂O₆), sucrose (C₁₂H₂₂O₁₁), fructose (C₆H₁₂O₆), maltodextrines with a chain length ranging from 2 units to 20 units, sorbitol (C₆H₁₄O₆), erythritol (C₄H₁₀O₄), mannitol (C₆H₁₄O₆), or CARBOSPERSE® K7028 (a short chain polyacrylic acid. M˜2.300 Da, available from Lubrizol). Low or moderate molecular weight polycarboxylic acids (e.g., having a molecular weight less than 5,000 Da) may dissolve relatively fast. It is to be understood that higher molecular weight polycarboxylic acids (e.g., having a molecular weight greater than 5,000 Da up to 10,000 Da) may be used; however the dissolution kinetics may be slower.

The composition may be prepared by mixing the high melt temperature build material, the first low melt temperature binder, and the second low melt temperature binder in a mixer, such as a double planetary mixer, an attritor, and the like. The composition may be used in a three-dimensional (3D) printer to form 3D parts.

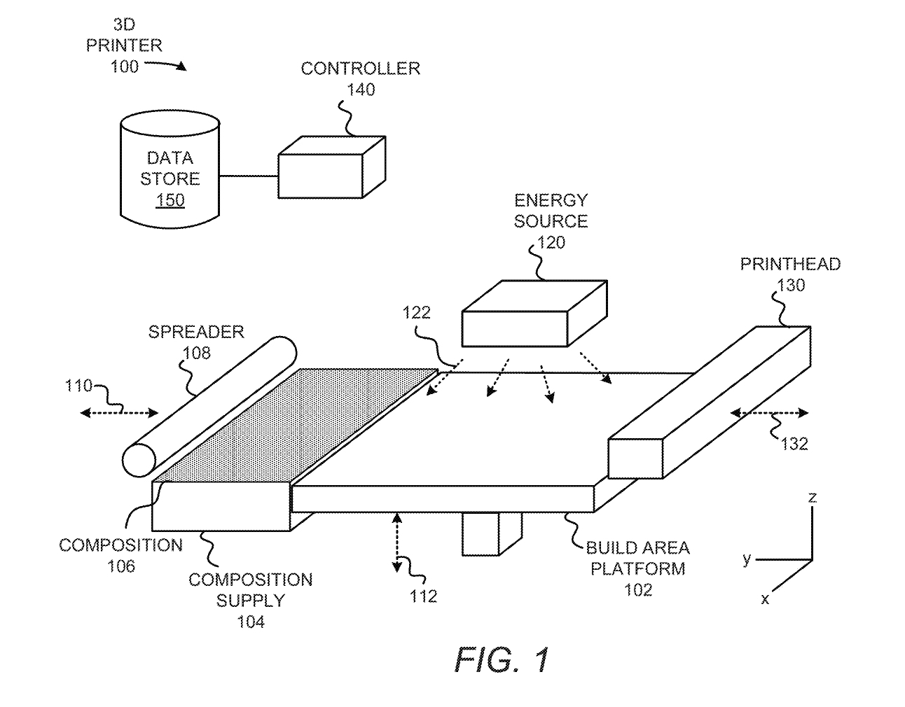

With reference first to FIG. 1, there is shown a simplified isometric view of an example 3D printer 100 for generating, building, or printing three-dimensional parts. It should be understood that the 3D printer 100 depicted in FIG. 1 may include additional components and that some of the components described herein may be removed and/or modified without departing from a scope of the 3D printer 100 disclosed herein. It should also be understood that the components of the 3D printer 100 depicted in FIG. 1 may not be drawn to scale and thus, the 3D printer 100 may have a different size and/or configuration other than as shown therein.

The 3D printer 100 is depicted as including a build area platform 102, a composition supply 104 containing the composition 106, and a spreader 108. The build area platform 102 may be integrated with the 3D printer 100 or may be a component that is separately insertable into the 3D printer 100, e.g., the build area platform 102 may be a module that is available separately from the 3D printer 100. The composition supply 104 may be a container or surface that is to position the composition 106 between the spreader 108 and the build area platform 102. The composition supply 104 may be a hopper or a surface upon which the composition 106 may be supplied. The spreader 108 may be moved in a direction as denoted by the arrow 110, e.g., along the y-axis, over the composition supply 104 and across the build area platform 102 to spread a layer of the composition 106 over a surface of the build area platform 102.

The 3D printer 100 is further depicted as including a printhead 130 that may be scanned across the build area platform 102 in the direction indicated by the arrow 132, e.g., along the y-axis. The printhead 130 may be, for instance, a thermal inkjet printhead, a piezoelectric printhead, etc., and may extend a width of the build area platform 102. Although a single printhead 130 has been depicted in FIG. 1, it should be understood that multiple printheads may be used that span the width of the build area platform 102. Additionally, the printheads 130 may be positioned in multiple printbars. The printhead 130 may also deposit an agent over a selected area of a layer of the composition 106.

The agent may be a composition including various components that may be applied to the layer of the composition 106. Non-limiting examples of components of the agent include a pigment, a dye, a solvent, a co-solvent, a surfactant, a dispersant, a biocide, an anti-cogation agent, viscosity modifiers, buffers, stabilizers, and combinations thereof. The presence of a co-solvent, a surfactant, and/or a dispersant in the agent may assist in obtaining a particular wetting behavior with the composition.

Surfactant(s) may be used to improve the wetting properties and the jettability of the agent. Examples of suitable surfactants may include a self-emulsifiable, nonionic wetting agent based on acetylenic diol chemistry (e.g., SURFYNOL® SEF from Air Products and Chemicals, Inc.), a nonionic fluorosurfactant (e.g., CAPSTONE® fluorosurfactants from DuPont, previously known as ZONYL FSO), and combinations thereof. In other examples, the surfactant may be an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6 from The Dow Chemical Company). In some examples, it may be desirable to utilize a surfactant having a hydrophilic-lipophilic balance (HLB) less than 10.

Some examples of a co-solvent include 1-(2-hydroxyethyl)-2-pyrollidinone, 2-Pyrrolidinone. 1,5-Pentanediol, Triethylene glycol, Tetraethylene glycol, 2-methyl-1,3-propanediol, 1,6-Hexanediol, Tripropylene glycol methyl ether, N-methylpyrrolidone, Ethoxylated Glycerol-1 (LEG-1), and combinations thereof.

Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from The Dow Chemical Co.).

Non-limiting examples of suitable anti-cogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol).

Following deposition of the agent onto selected areas of the layer of the composition 106, the build area platform 102 may be lowered as denoted by the arrow 112, e.g., along the z-axis. In addition, the spreader 108 may be moved across the build area platform 102 to form a new layer of composition 106 on top of the previously formed layer. Moreover, the printhead 130 may deposit the agent onto predetermined areas of the new layer of composition 106. The above-described process may be repeated until a predetermined number of layers have been formed to fabricate a green body of a desired 3D part.

As also shown in FIG. 1, the 3D printer 100 may include a controller 140 that may control operations of the build area platform 102, the composition supply 104, the spreader 108, the energy source 120, and the printhead 130. The controller 140 is also depicted as being in communication with a data store 150. The data store 150 may include data pertaining to a 3D part to be printed by the 3D printer 100.

A green body may be created from areas of the composition 106 that have received the agent from the printhead 130 or from areas of the composition that have not received the agent. In order to successfully form a green body, there should be an absorption difference of at least about 15% to about 20% between the spread composition and the selectively deposited agent. For example, if the spread composition is light in the color of its appearance, which may be the case with compositions including a high melt temperature ceramic or polymer build material, then the selectively applied agent should be dark in the color of its appearance. Compositions that may have a light appearance weakly absorb the applied energy, i.e., most of the applied energy is reflected. In an example, a spread composition that is light in the color of its appearance may include aluminum, aluminum alloys, copper, or most ceramic metal oxides as the high melt temperature build material.

Similarly, if the spread composition is dark in the color of its appearance, which may be the case with compositions including a high melt temperature metal or metal alloy build material, then the selectively applied agent should be light in the color of its appearance. Compositions that have a dark appearance strongly absorb the applied energy, for example, in the spectral range corresponding to an emission of the energy source 120. In an example, maximum absorption by the spread composition may fall into near infrared and long wavelength parts of the visible range. In an example, a spread composition that is dark in the color of its appearance may include stainless steel, Ni—Mo—Cr alloys, or cobalt chromium alloys as the high melt temperature build material.

In an example, when the composition is light in color of its appearance an agent having a dark color in appearance may be selectively deposited over a first area of the spread composition that will form the green body. This will leave a second area of the spread composition that will not form the green body. Upon application of the energy 122, such as by heat lamps, ultraviolet lights, and the like, the selectively deposited agent may absorb the energy and cause the first low melt temperature binder and the second low melt temperature binder in the spread composition to melt. The melted binders may provide shape integrity to the green body. The second area of spread composition may reflect the applied energy, which may inhibit the first low melt temperature binder and the second low melt temperature binder in the spread composition from melting.

In another example, when the composition is dark in color of its appearance an agent having a light color in appearance may be selectively deposited over a second area of the spread composition that will not form the green body. This will leave a first area of the spread composition that will form the green body. Upon application of the energy, such as by heat lamps, ultraviolet lights, and the like, the selectively deposited agent may reflect the applied energy, which may inhibit the first low melt temperature binder and the second low melt temperature binder in the spread composition from melting. The first area of spread composition may absorb the applied energy, which may cause the first low melt temperature binder and the second low melt temperature binder in the spread composition to melt. The melted binders may provide shape integrity to the green body.

The applied energy may be removed and the green body may cool by removal of the energy. Upon cooling, the formed green body may solidify. The formed green body may be removed from the build platform.

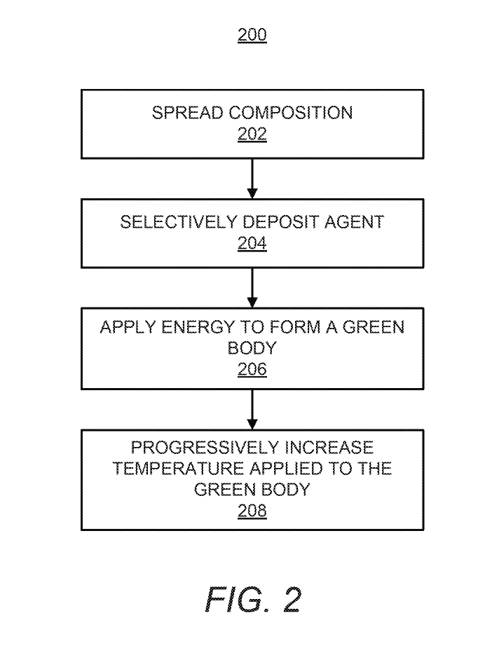

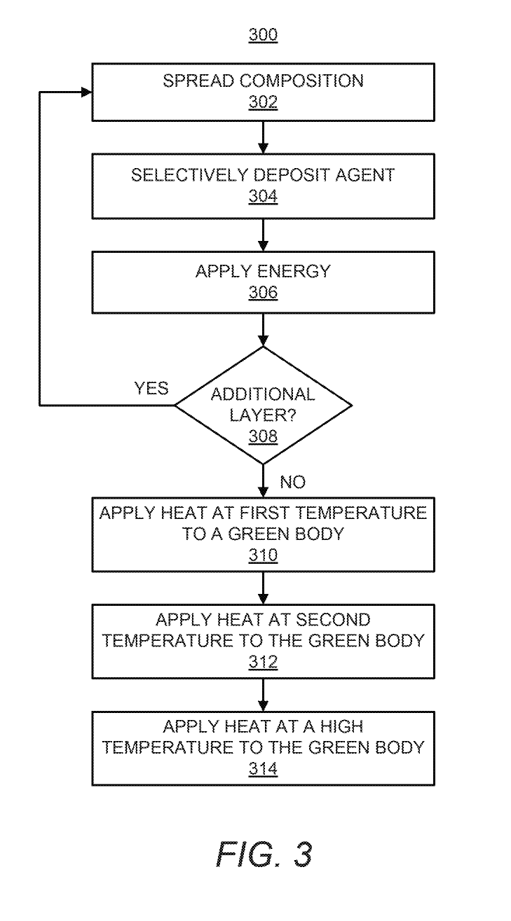

Various manners in which an example 3D part may be fabricated are discussed in greater detail with respect to the example methods 200 and 300 respectively depicted in FIGS. 2 and 3. It should be apparent to those of ordinary skill in the art that the methods 200 and 300 may represent generalized illustrations and that other operations may be added or existing operations may be removed, modified, or rearranged without departing from the scopes of the methods 200 and 300.

The descriptions of the methods 200 and 300 are made with reference to the 3D printer 100 illustrated in FIG. 1 for purposes of illustration. It should, however, be clearly understood that 3D printers and other types of apparatuses having other configurations may be implemented to perform either or both of the methods 200 and 300 without departing from the scopes of the methods 200 and 300.

Prior to execution of the method 200 or as part of the method 200, the 3D printer 100 may access data pertaining to a 3D part that is to be printed. By way of example, the controller 140 may access data stored in the data store 150 pertaining to a 3D part that is to be printed. The controller 140 may determine the number of layers of composition 106 that are to be formed and the locations at which an agent from the printhead 130 is to be deposited on each of the respective layers of composition 106 in order to print the 3D part.

With reference first to FIG. 2, at block 202, a composition 106 may be spread over a build area platform 102. As discussed herein, the composition 106 may be formed of powder in the form of a high temperature build material, a first low temperature binder, and a second low temperature binder. In addition, at block 204, an agent may be selectively deposited onto areas of the spread composition 106. As discussed above, depending upon the composition 106 and the agent being applied, the agent may be deposited onto the areas of the composition 106 that are to form a part or parts of a green body or may be deposited onto the areas of the composition 106 that are not to form a part or parts of a green body. In addition, in some examples, a plurality of agents may be selectively deposited onto the composition 106. In these examples, one of the agents may be applied to the areas that are to form a part of the green body and another one of the agents may be applied to the areas that are not to form a part of the green body.

At block 206, energy 122 may be applied onto the spread composition 106 and the selectively deposited agent to form a green body. Block 206 may represent a plurality of operations in which multiple layers of composition 106 are spread, selectively deposited with agent, and supplied with energy to form the green body, in which parts of the green body are formed in each of the successively formed layers.

At block 208, a temperature applied to the green body may be progressively increased from a first temperature, to a second temperature, and to a high temperature. That is, the green body may be subjected to a first temperature for a first period of time, to a second temperature for a second period of time, and then to a high temperature for a third period of time. In addition, the first temperature may be equal to approximately a melting temperature of the first low melt temperature binder, the second temperature may be equal to approximately a melting temperature of the second low temperature binder, and the high temperature may be equal to approximately a melting temperature of the high melt temperature build material.

Turning now to FIG. 3, at block 302, the composition 106 may be spread and at block 304, an agent may be selectively deposited onto the spread composition 106. Blocks 302 and 304 may be similar to blocks 202 and 204 discussed above with respect to FIG. 2. In addition, at block 306, energy 122 may be applied in manners similar to those discussed above with respect to block 206. At block 308, a determination may be made, for instance, by a processor of the 3D printer 100, as to whether an additional layer of the composition 106 is to be formed. In response to a determination that another layer of the composition 106 is to be formed, blocks 302-308 may be repeated on top of a previously deposited layer.

However, in response to a determination that an additional layer of composition 106 is not to be formed, the formed layers, e.g., green body, may be removed from the 3D printer 100. Removal of the green body may cool, which may cause the melted binders contained in the green body to solidify.

As a further processing operation on the green body, extraneous composition that has been unintentionally attached to the green body may be removed. By way of example, the green body may be placed in a media blasting cabinet and the extraneous composition may be sandblasted away from the green body. As another example, the extraneous composition may be removed through mechanical vibration or other removal techniques.

Following removal of the extraneous composition, heat or radiation may be applied to the green body from a heat or radiation source (not shown). By way of example, the green body may be placed into a furnace or oven that is able to heat the green body at different temperatures, in which the different temperatures may range from a temperature that is approximately equal to the melting temperature of the first low temperature binder to a temperature that is sufficient to cause the high temperature melt material in the green body to melt and/or sinter. In another example, the green body may be placed in multiple furnaces or ovens that are each at different temperatures during successive periods of time, in which the different temperatures may respectively be approximately equal to the melting temperatures of the first low temperature binder, the second low temperature binder, and the high temperature binder material.

The temperatures at which the heat is applied may be progressively increased from a first temperature, to a second temperature, and to a high temperature. That is, at block 310, heat may be applied to the green body at a first temperature, which may be equal to approximately a melting temperature of the first low melt temperature binder. At block 312, which may be implemented after a predetermined period of time following block 310, heat may be applied to the green body at a second temperature, which may be equal to approximately a melting temperature of the second low melt temperature binder. At block 314, which may be implemented after a predetermined period of time following block 312, heat may be applied to the green body at a high temperature, which may be equal to approximately a melting temperature of the high melt temperature build material.

The progressively increasing temperature may dissolve the first low melt temperature binder and the second low melt temperature binder. In an example, as the temperature progressively increases a first low melt temperature binder may begin to melt and may provide some shape integrity to the green body. As the temperature continues to increase, the first low melt temperature binder may start to dissolve as the second low melt temperature binder begins to melt. The melting second low melt temperature binder may provide some shape integrity to the green body as it melts into the areas of the green body voided by the dissolving first low melt temperature binder. As the temperature continues to increase, the second low melt temperature binder may start to dissolve as the high melt temperature build material begins to sinter.

By way of example, the temperature may progressively increase from about room temperature to about 100° C. to about 230° C. to above around 1000° C. and in other examples, above around 1500° C. In addition, the increasing temperature may cause the density of the green body to be increased. The length of time at which the heat is applied may be dependent, for example, on one or more of: characteristics of the heat or radiation source, characteristics of the build material: and/or characteristics of the agent. In an example, the heat may be applied in an oxidizing or a reducing atmosphere and with or without an inert gas. In another example, the oxidizing and reducing atmospheres may also be used during annealing of the green body to facilitate removal of the molten binder from inside and from the vicinity of the heated green part.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A composition comprising:
a high melt temperature build material in the form of a powder;
a first low melt temperature binder in the form of a powder; and
a second low melt temperature binder in the form of a powder; and
wherein the first low melt temperature binder melts at a temperature that is different from the second low melt temperature binder.

2. The composition of claim 1, wherein the high melt temperature build material is selected from the group consisting of metals, metal alloys, ceramics, and polymers.

3. The composition of claim 1, wherein the first low melt temperature binder and the second low melt temperature binder are independently selected from the group consisting of polypropylene, polyethylene, low density polyethylene, high density polyethylene, polyethylene oxide, polyethylene glycol, acrylonitrile butadiene styrene, polystyrene, styrene-acrylonitrile resin, polyphenyl ether, polyamide 11, polyamide 12, polymethyl pentene, polyoxymethylene, polyethylene terephthalate, polybutylene terephthalate, polyvinylidene fluoride, polytetrafluoroethylene, perfluoroalkoxy alkane, polyphenylene sulfide, and polyether ether ketone.

4. The composition of claim 1, wherein the first low melt temperature binder and the second low melt temperature binder each have a melting point temperature less than about 250° C.

5. The composition of claim 1, wherein the first low melt temperature binder and the second low melt temperature binder are present in the composition in an amount ranging from about 1% to about 6% by volume.

6. The composition of claim 1, wherein the first low melt temperature binder and the second low melt temperature binder are a crystalline polymer.

7. The composition of claim 1, wherein the first low melt temperature binder and the second low melt temperature binder are a non-crystalline polymer.

8. A method comprising:
spreading a composition on a platform, wherein the composition is a powder mixture comprising a high melt temperature build material, a first low melt temperature binder, and a second low melt temperature binder;
selectively depositing an agent on the spread composition;
applying energy to form a green body from the spread composition; and
progressively increasing a temperature applied to the green body from a first temperature, to a second temperature, and to a high temperature, wherein the first temperature is equal to approximately a melting temperature of the first low melt temperature binder, the second temperature is equal to approximately a melting temperature of the second low temperature binder, and the high temperature is a melting temperature of the high melt temperature build material.

9. The method of claim 8, wherein the agent is selectively deposited over a first area of the spread composition that will form the green body leaving a second area of the spread composition that will not form the green body.

10. The method of claim 9, wherein the selectively deposited agent absorbs the applied energy and causes the first low melt temperature binder and the second low melt temperature binder in the spread composition to melt.

11. The method of claim 8, wherein the agent is selectively deposited over a second area of the spread composition that will not form the green body leaving a first area of the spread composition that will form the green body.

12. The method of claim 11, wherein the selectively deposited agent reflects the applied energy and inhibits the first low melt temperature binder and the second low melt temperature binder in the spread composition from melting.

13. The method of claim 11, wherein the first area of the spread composition absorbs the applied energy and causes the first low melt temperature binder and the second low melt temperature binder in the spread composition to melt.

14. The method of claim 8, further comprising removing the applied energy and cooling the green body before progressively increasing the temperature.

15. The method of claim 8, wherein the progressively increasing temperature dissolves the first low melt temperature binder and the second low melt temperature binder and sinters the high melt temperature build material.
